(19) United States
(12) Patent Application Publication
(10) Pub. No.: US 2002/0076516 A1
(43) Pub. Date: Jun. 20, 2002

(54) Protective corner strip for suitcase

(76) Inventor: Wei Chih Chen, Da Gia Town (TW)

Correspondence Address: CHARLES E. BAXLEY, 5th Floor, 59 John Street, New York, NY, 10038, US

(21) Appl. No.: 09/738,056

(22) Filed: Dec. 18, 2000

(51) Int. Cl. B32B 1/08

(52) U.S. Cl. 428/36.9; 428/99

(57) ABSTRACT

A protective corner strip for attaching onto a corner of a suitcase includes an elongated tubular member having a number of orifices of various kinds of decorative shapes formed through the elongate tubular member for increasing a flexibility of the elongate tubular member and for facilitating an attachment of the elongate tubular member onto the corner of the suitcase. The elongated tubular member includes two edge panels for securing to the suitcase and each having a number of teeth for increasing a flexibility of the panels.

### BACKGROUND OF THE INVENTION

1. Field of the Invention

The present invention relates to a protective corner strip, and more particularly to a protective corner strip for suitcases or the like.

2. Description of the Prior Art

Typical protective corner strips are provided for attaching onto the corners of the suitcases or the like and are normally made of metal materials that are formed according to the shapes of the corners of the suitcases, such that the metal protective corner strips may not be bent or deformed according to the shapes of the other suitcases and thus may not be attached onto the other suitcases.

The present invention has arisen to mitigate and/or obviate the afore-described disadvantages of the conventional protective corner strips for suitcases.

### SUMMARY OF THE INVENTION

The primary objective of the present invention is to provide a protective corner strip which is made of flexible materials for allowing the protective corner strip to be bent and to be attached onto the corners of various kinds of suitcases.

In accordance with one aspect of the invention, there is provided a protective corner strip for attaching onto a corner of a suitcase, the protective corner strip comprising an elongated tubular body including a plurality of orifices formed therein and formed through the elongate tubular body for increasing a flexibility of the elongate tubular body and for facilitating an attachment of the elongate tubular body onto the corner of the suitcase.

The elongated tubular body includes a pair of edges each having a panel extended therefrom for defining a slot therebetween and for securing to the suitcase. The panels each includes an edge distal to the elongate tubular body and having a plurality of teeth formed therein for increasing a flexibility of the panels and for allowing the panels to be easily bent and curved and attached onto the corners of the suitcase.

The orifices of the elongate tubular body each preferably includes a hexagonal shape. The elongate tubular body includes two ends each having a peripheral flange extended therefrom for increasing the strength of the ends of the elongate tubular body.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a suitcase having a protective corner strip in accordance with the present invention;

FIG. 2 is an enlarged partial perspective view of the suitcase having the protective corner strip attached thereon;

FIG. 3 is a partial cross sectional view taken along lines 3-3 of FIG. 2;

FIG. 4 is a perspective view illustrating one embodiment of the protective corner strip;

FIG. 5 is a plane view of the protective corner strip as shown in FIG. 4; and

FIG. 6 is a perspective view illustrating the other embodiment of the protective corner strip.

### DETAILED DESCRIPTION OF THE PREFERRED EMBODIMENT

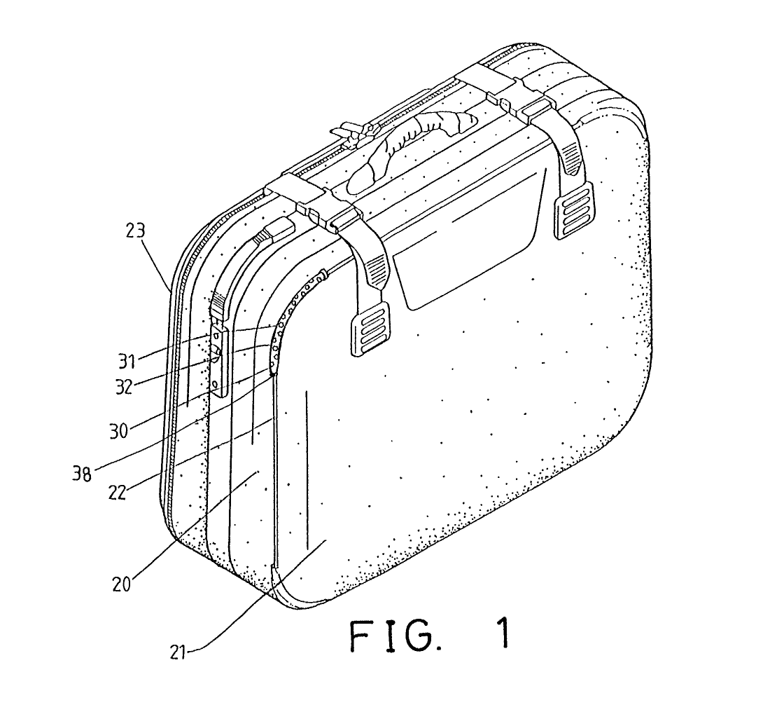

Referring to the drawings, and initially to FIGS. 1-3, a suitcase 20 may include a number of corners 22 formed in the base portion 21 or in the cover portion 23. A protective corner strip 30 in accordance with the present invention is provided for attaching onto either of the corners 22 of the suitcase 20, and comprises an elongated tubular body 31 including a number of orifices 32 formed therein and formed through the elongate tubular body 31, best shown in FIG. 3. The elongate tubular body 31 is preferably made of flexible materials, such as the rubber materials, the synthetic materials, or the like, for allowing the elongate tubular body 31 to be easily bent or curved and attached onto the corners of various kinds of suitcases. The provision or the formation of the orifices 32 in the elongated tubular body 31 may increase the flexibility of the elongate tubular body 31 for further allowing the elongate tubular body 31 to be easily bent or curved and attached onto the corners of various kinds of suitcases.

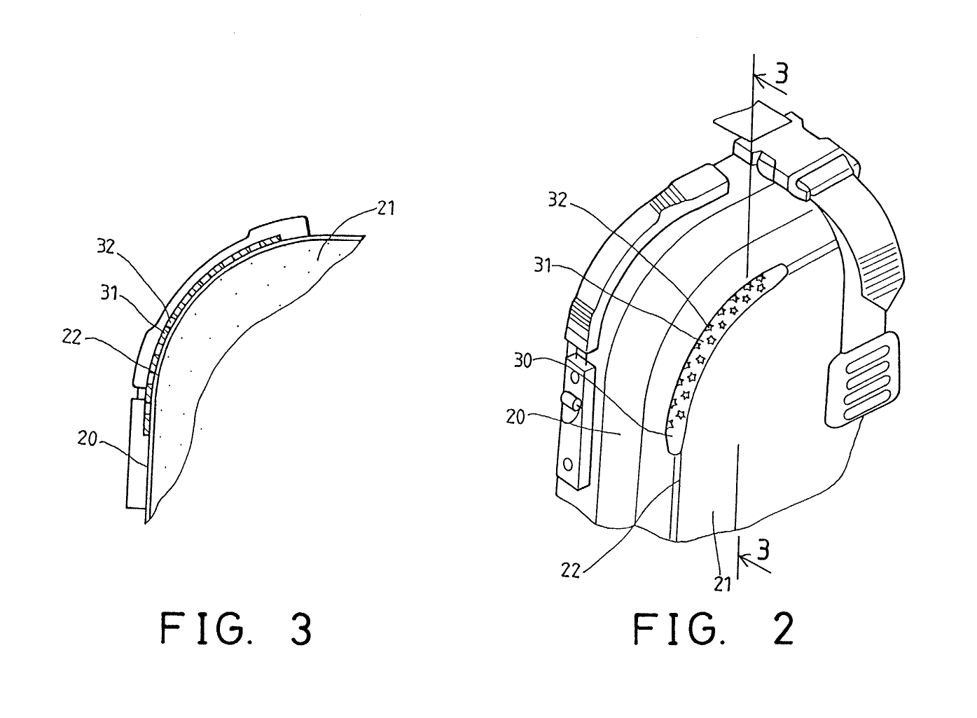

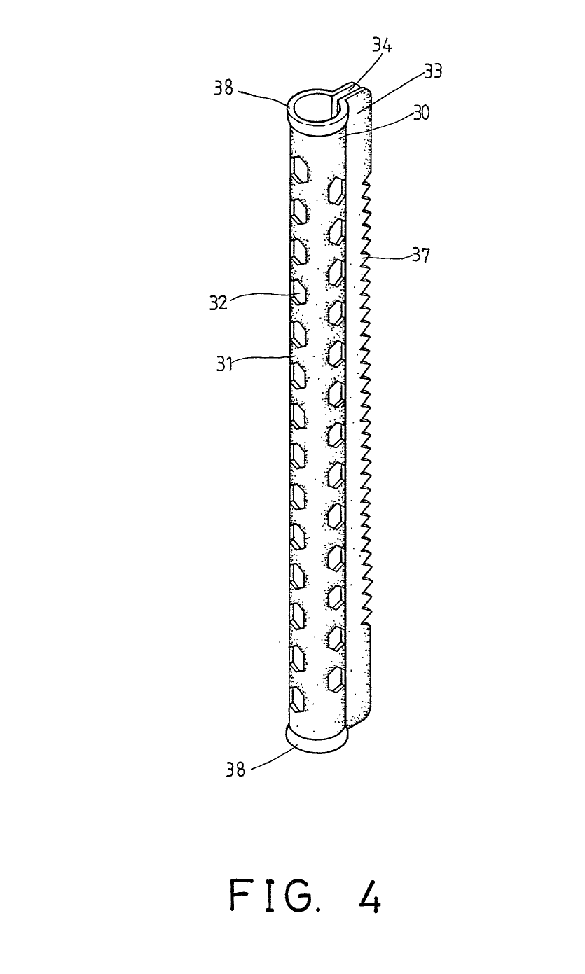

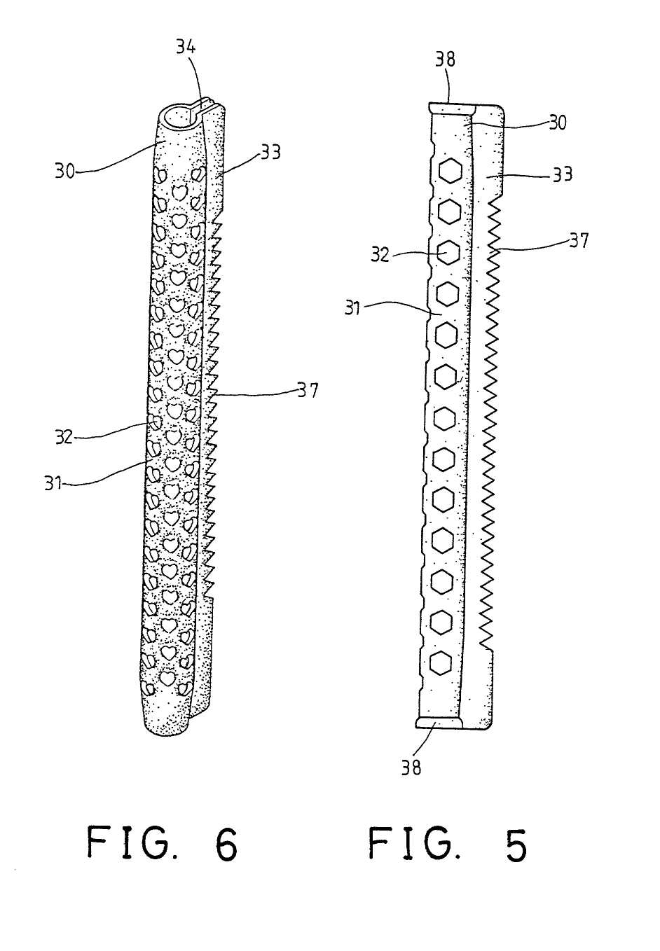

The orifices 32 of the elongate tubular body 31 may include various kinds of shapes, such as the hexagonal shape as shown in FIGS. 1 and 4-5, or the star shape as shown in FIG. 2, or the heart shape as shown in FIG. 6. The different shapes of the orifices 32 of the elongate tubular body 31 may affect or may form different flexibility to the elongate tubular body 31 for facilitating the engagement of the elongate tubular body 31 onto various kinds of corners of various kinds of suitcases. The elongate tubular body 31 may include two ends each having a peripheral flange 38 extended laterally or radially outward therefrom for increasing the strength of the ends of the elongate tubular body 31.

The elongated tubular body 31 includes a pair of edges each having a panel 33 extended therefrom and preferably parallel to each other for defining a slot 34 therebetween. The panels 33 are extended from the elongate tubular body 31, or each includes one edge attached to or formed integral with the elongate tubular body 31 and each includes the other edge distal to the elongate tubular body 31. The other edges of the panels 33 of the elongate tubular body 31 each includes a serrated surface 37 or each includes a number of teeth formed therein for increasing the flexibility of the panels 33 of the elongate tubular body 31 and for allowing the panels 33 of the elongate tubular body 31 to be easily bent or curved and attached onto the corners of various kinds of suitcases. The panels 33 may be engaged on the outer portion of the suitcase, but are preferably engaged into the suitcase, and are preferably secured to the suitcase with fasteners, adhesive materials, stitches or the like.

Accordingly, the protective corner strip in accordance with the present invention is made of flexible materials for allowing the protective corner strip to be bent and to be attached onto the corners of various kinds of suitcases.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A protective corner strip for attaching onto a corner of a suitcase, said protective corner strip comprising:
an elongated tubular body including a plurality of orifices formed therein and formed through said elongate tubular body for increasing a flexibility of said elongate tubular body and for facilitating an attachment of said elongate tubular body onto the corner of the suitcase.

2. The protective corner strip according to claim 1, wherein said elongated tubular body includes a pair of edges each having a panel extended therefrom for defining a slot therebetween and for securing to the suitcase.

3. The protective corner strip according to claim 2, wherein said panels each includes an edge distal to said elongate tubular body and having a plurality of teeth formed therein for increasing a flexibility of said panels.

4. The protective corner strip according to claim 1, wherein said orifices of said elongate tubular body each includes a hexagonal shape.

5. The protective corner strip according to claim 1, wherein said elongate tubular body includes two ends each having a peripheral flange extended therefrom.
